(19) United States
(12) Patent Application Publication
(10) Pub. No.: US 2025/0003258 A1
(43) Pub. Date: Jan. 2, 2025

(54) IMPROVED DOOR LOCK FOR A HOUSEHOLD APPLIANCE

(71) Applicant: ILLINOIS TOOL WORKS INC., GLENVIEW, IL (US)

(72) Inventors: Dino CHIRUMBOLO, Barasso (IT); Bojan BICIC, Tolmin (SI); Joze LAVRENCIC, Tolmin (SI)

(73) Assignee: ILLINOIS TOOL WORKS INC., GLENVIEW, IL (US)

(21) Appl. No.: 18/705,053

(22) PCT Filed: Oct. 17, 2022
(86) PCT No.: PCT/US2022/046860

§ 371 Date: Apr. 26, 2024

(30) Foreign Application Priority Data
Oct. 27, 2021 (EP) 21205124.7
Mar. 8, 2022 (EP) 22160720.3

(51) Int. Cl. E05B 47/00; E05B 65/00

(52) U.S. Cl. CPC E05B 47/0004; E05B 65/00; E05B 2047/0016; E05B 2047/0025; E05B 2047/0068

(57) ABSTRACT

A door locking device for a door of a household appliance is provided, the device comprising: a housing; a coupling member, having a first end portion and a second end portion, pivotally mounted at a fulcrum within said housing; an actuator, operably coupled to said first end portion of said coupling member and adapted to controllably move said coupling member between a first position and a second position about said fulcrum; a locking pin, operably coupled to said second end portion of said coupling member and configured to slidably move between an unlocked position, when said coupling member is in said first position, and a locked position, when said coupling member is in said second position; wherein said fulcrum is located between said first end portion and said second end portion so as to provide a mechanical lever advantage for a force applied to said first end portion by said actuator and imparted onto said locking pin by said second end portion.

### TECHNICAL FIELD OF INVENTION

This invention relates to a door lock, and in particular to a solenoid door lock for locking and unlocking a door of a household appliance such as a washing machine, a dishwasher, a self-cleaning oven or a refrigerator.

### BACKGROUND

It is commonly known that household appliances, such as washing machines dishwashers, self-cleaning ovens and refrigerators employ door locking devices to lock the door of the appliance. For example, washing machines, dishwashers and self-cleaning ovens employ door locking device to lock the door of the appliance prior to actuating a washing cycle. Such devices prevent opening of the door during a washing cycle of the household appliance. These devices can also prevent actuation of the washing cycle when the door remains open.

Typically, door locking devices are controlled by a solenoid which, in response to pulses received from a controller of the household appliance, actuates the device through a series of mechanical components to mechanically lock or unlock the door of the household appliance. These door locking devices can also include switches which sense the open or closed condition of the door. This switch blocks transmission of the pulses to the solenoid when the door is open. Such a switch is indirectly closed by the door of the appliance when the door is brought into a closed position and once the switch is closed, the pulses can be supplied to the solenoid thereby triggering the locking the door in the closed position. These devices have a large number of components in order to transform the pulses received from the controller to movement of the mechanical lock. Such arrangements are complex and thus difficult to manufacture, they have many points of failure. Furthermore, the solenoid used in these devices must be sufficiently large to generate enough force to move the mechanical lock.

Consequently, it is an object of the present invention to provide an improved door lock capable of mitigating at least some of the drawbacks mentioned above. In particular, it is an object of the present invention to provide a door lock which has fewer components, thus improving the ease of assembly and reducing the size of the device.

### SUMMARY OF THE INVENTION

An aspect of the invention is set out in the independent claim. Dependent claims describe optional features.

In one aspect of the invention there is provided a door locking device for a door of a household appliance, the device comprising:
a housing;
a coupling member, having a first end portion and a second end portion, pivotally mounted at a fulcrum within said housing;
an actuator, operably coupled to said first end portion of said coupling member and adapted to controllably move said coupling member between a first position and a second position about said fulcrum;
a locking pin, operably coupled to said second end portion of said coupling member and configured to slidably move between an unlocked position, when said coupling member is in said first position, and a locked position, when said coupling member is in said second position;
wherein said fulcrum is located between said first end portion and said second end portion so as to provide a mechanical lever advantage for a force applied to said first end portion by said actuator and imparted onto said locking pin by said second end portion.

This provides the advantage that the coupling member is operably coupled to both the actuator and the locking pin, thereby simplifying the arrangement of components in the locking device. Furthermore, the mechanical lever advantage of the coupling member allows for an actuator having less power to be utilised in the device. This allows for the size of the actuator, and thus the size of the door locking device, to be reduced.

Advantageously, said second end portion of said coupling member may comprise at least one first cam guide operably coupled with a corresponding first cam follower of said locking pin. Said cam guide may be provided by a thread member coaxially arranged with and extending about a pivot axis of said fulcrum. Said thread member may be a thread portion defining a predetermined thread segment along a helical path about said pivot axis of said fulcrum. Said thread segment may cover an angular range from approximately 45 degrees to 180 degrees.

Advantageously, said door locking device may further comprise a guide arm, having a longitudinal axis and extending between a first guide arm end portion, pivotally coupled to said actuator at a pivot point, and a second guide arm end portion, operably coupled to said first end portion of said coupling member, wherein said guide arm is configured to move about said pivot point between a first arm position and a second arm position, and wherein said guide arm is adapted to latch said coupling member in at least one predetermined resting position when said coupling member is moved between said first position and second position.

Advantageously, said door locking device may further comprise a biasing member operably coupled to said coupling member and configured to bias said coupling member towards said first position. Said biasing member may be operably coupled to said guide arm and configured to bias said guide arm towards said first arm position. Said first arm position may be towards said fulcrum of said coupling member.

Advantageously, said guide arm portion may comprise two radially opposing stop members protruding laterally away from a longitudinal axis of said guide arm at said first guide arm end portion. Said guide arm may comprise a pin provided on one of said stop members, radially offset the pivot point, thereby defining a lever between second guide arm end portion and said pin about said pivot point, wherein said pin is operably connectable to said biasing member.

Advantageously, said guide arm may comprise a second cam follower at said second guide arm end portion configured to operably couple with a corresponding second cam guide at said first end portion of said coupling member. Said second cam guide may be a guide path defined by a recessed circuit. Said recessed circuit may comprise a first notch adapted to hold said second cam follower thereby holding said guide arm in said at least one predetermined resting position. Said recessed circuit may comprise a second notch adapted to hold said second cam follower thereby holding said guide arm in a second predetermined resting position.

Advantageously, the door locking device may further comprise a switch assembly, said switch assembly comprising: a first terminal, electrically connected to said actuator, a second terminal, electrically connected to said actuator so as to form an electrical power circuit with said first terminal and a power source circuit of the household appliance, and a third terminal, selectively electrically connectable to said second terminal and an external interface so as to form a signal circuit with a controller of the household appliance.

Advantageously, said third terminal may comprise a main switch element moveable between an open position in which said third terminal is electrically disconnected from said second terminal, and a closed position in which said third terminal is electrically connected to said second terminal. Said main switch element of said third terminal may comprise a third cam follower configured to operably engage with a corresponding third cam guide provided at said second end portion of said coupling member so as to move said main switch element between said open position and said closed position in accordance with respective said first position and said second position of said coupling member. Said main switch element may be biased towards said closed position.

Advantageously, the door locking device may further comprise a cut-out member, adapted to operably engage with said third cam follower and move said main switch element into said open position when the door of the household appliance is opened.

Advantageously, said second terminal may comprise a main switch element moveable between an open position in which said actuator is electrically disconnected from the power source circuit, and a closed position in which said actuator is electrically connected to the power source circuit. Said main switch element may be biased towards said closed position. A door sensing pin may be operably coupled between the door of the household appliance and said main switch element of said second terminal, the door sensing pin configured to move between an engaged position when the door is open, retaining said main switch element into said open position, and a disengaged position when the door is closed, where said main switch element is in said closed position.

Advantageously, the door locking device may further comprise a PTC (Positive Temperature Coefficient) thermistor operably coupled between said actuator and said first terminal.

Advantageously, said actuator may comprise: a solenoid, and a core, slidably received within said solenoid and operably coupled to said first end portion of said coupling member.

### BRIEF DESCRIPTION OF THE DRAWINGS

An exemplary embodiment of the invention is explained in more detail hereinbelow with reference to the figures:

FIG. 1 shows an example embodiment of a door locking device of the present invention in a perspective view (a) within a housing, (b) with a portion of the housing removed, and (c) with the housing removed;

FIG. 2 shows the door locking device of FIG. 1 (housing not shown) (a) in a top, perspective view, and (b) in a bottom, perspective view;

FIG. 3 shows the door locking device of FIG. 1 in an exploded, perspective view;

FIG. 4 shows the door locking device of FIG. 1 (housing not shown) in a top view;

FIG. 5 shows the door locking device of FIG. 1 (housing not shown) in a bottom view;

FIG. 6 shows a coupling member, a locking pin, and a guide arm of the door locking device of FIG. 1 in a perspective, bottom view (a) in a first, unlocked position, and (b) in a second, locked position;

FIG. 7 shows the coupling member, the locking pin, and the guide arm of FIG. 6(b) in a top view with a transparent coupling member;

FIG. 8 shows the door locking device of FIG. 1 (housing not shown) in a perspective, side view (a) in the first, unlocked position, and (b) in the second, locked position;

FIG. 9 shows the door locking device of FIG. 1 (housing not shown) in a cross-sectional, perspective view at line A-A of FIG. 4;

FIG. 10 shows the door locking device of FIG. 1 in a cross-sectional, side view;

FIG. 11 shows a circuit diagram of the door locking device;

FIG. 12 shows a diagram of the working cycle of the locking device (a) with one unlocking pulse, and (b) with two unlocking pulses;

FIG. 13 shows the door locking device of FIG. 1 (housing not shown) in a bottom view of the coupling member (a) in the first position, (b) in the in the second position, (c) in the first predetermined resting position, and (d) in the second predetermined resting position;

FIG. 14 shows the door locking device of FIG. 1 (housing not shown) (a) in a front view of the coupling member in the first position, (b) in a front view of the coupling member in the second position, and (c) in a bottom, perspective view of the coupling member in the second predetermined resting position;

FIG. 15 shows perspective views of (a) the coupling member and an alternative second cam guide (path) and (b) the guide arm comprising a detailed view of the shape of the guide pin;

FIG. 16 shows an alternative embodiment of the door locking device (housing not shown) (a) in a top, perspective view, and (b) in a top view;

FIG. 17 shows the alternative embodiment of the door locking device of FIG. 16 (a) in a bottom, perspective view, and (b) in a bottom view;

FIG. 18 shows the alternative door locking device of FIG. 16 (housing not shown) in (a) a perspective, side view and (b) a front view with the coupling member in the second position and the locking pin in the unlocked position;

FIG. 19 shows the alternative door locking device of FIG. 16 (housing not shown) in (a) a perspective, side view and (b) a front view with the coupling member in the first position and the locking pin in the locked position;

FIG. 20 shows a detailed view of the coupling member, the locking pin and the guide arm (a) when the locking pin is in the unlocked position (coupling member is in the second position), and (b) when the locking pin is in the locked position (coupling member is in the first position);

FIG. 21 shows a detailed view of the coupling member (a) from the top (showing the first cam guide, and (b) from the bottom (showing the third cam guide with ramp), and

FIG. 22 shows a detailed view of the guide arm.

### DETAILED DESCRIPTION

The described example embodiment relates to a solenoid door locking device for a household appliance, and particularly, a solenoid door locking device for locking and unlocking a door of a washing machine or a dishwasher. However, the invention is not limited to door locking devices for household appliances such as washing machines or dishwashers but may also be used for doors which require controlled locking and unlocking. Through the description, the terms ‘door lock’ and ‘door locking device’ are used interchangeably.

Certain terminology is used in the following description for convenience only and is not limiting. The words ‘right’, ‘left’, ‘lower’, ‘upper’, ‘front’, ‘rear’, ‘upward’, ‘down’, ‘downward’, ‘above’ and ‘below’ designate directions in the drawings to which reference is made and are with respect to the described component when assembled and mounted (e.g. in situ). The words ‘inner’, ‘inwardly’ and ‘outer’, ‘outwardly’ refer to directions toward and away from, respectively, a designated centreline or a geometric centre of an element being described (e.g., central axis), the particular meaning being readily apparent from the context of the description.

Further, as used herein, the terms ‘connected’, ‘attached’, ‘coupled’, ‘mounted’ are intended to include direct connections between two members without any other members interposed therebetween, as well as indirect connections between members in which one or more other members are interposed therebetween. The terminology includes the words specifically mentioned above, derivatives thereof, and words of similar import.

Further, unless otherwise specified, the use of ordinal adjectives, such as, ‘first’, ‘second’, ‘third’ etc. merely indicate that different instances of like objects are being referred to and are not intended to imply that the objects so described must be in a given sequence, either temporally, spatially, in ranking or in any other manner.

Through the description and claims of this specification, the terms ‘comprise’ and ‘contain’, and variations thereof, are interpreted to mean ‘including but not limited to’, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality, as well as, singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract or drawings), or to any novel one, or any novel combination, of the steps of any method or process so disclosed.

The present invention relates to a door locking device adapted to lock a door of a washing machine or a dishwasher during a wash cycle.

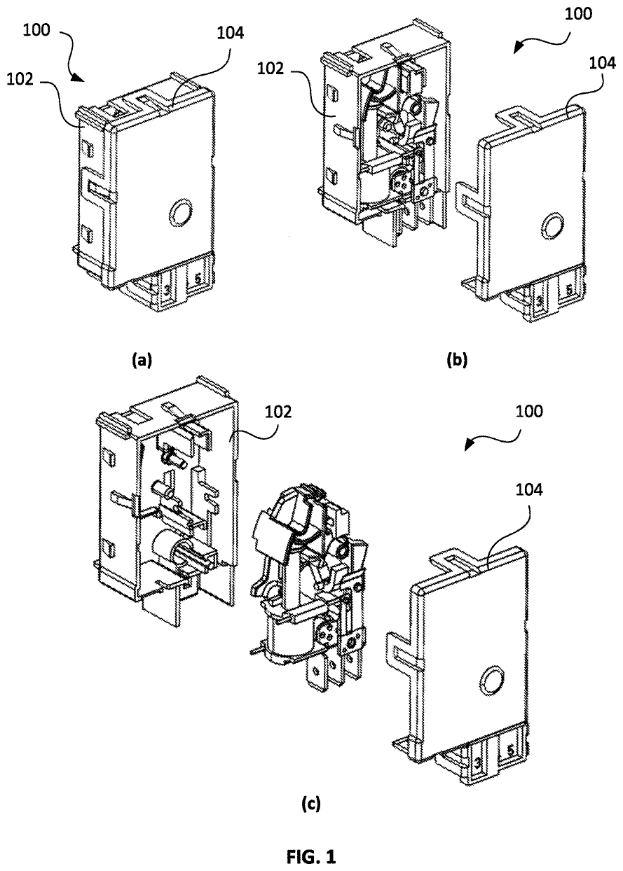

Referring now to FIGS. 1(a) to 1(c), the door locking device 100 includes a housing having a housing portion 102 and a cover portion 104. The housing encases the internal components of the door locking device 100, as shown in FIGS. 1(b) and 1(c). The door locking device 100 is installed within the household appliance beside a door hooking device (not shown) such that the door locking device 100 interacts with the door hooking device to lock the door of the household appliance, as discussed in further detail below.

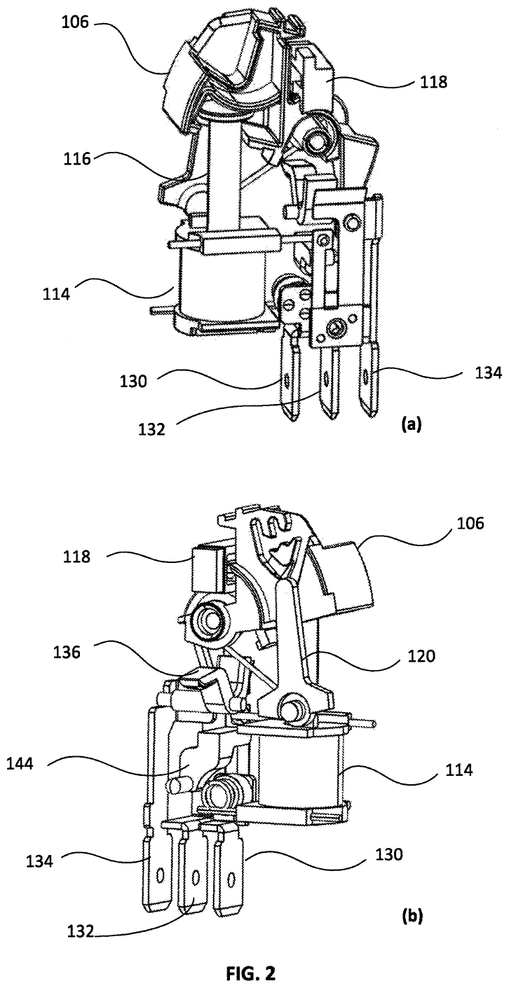

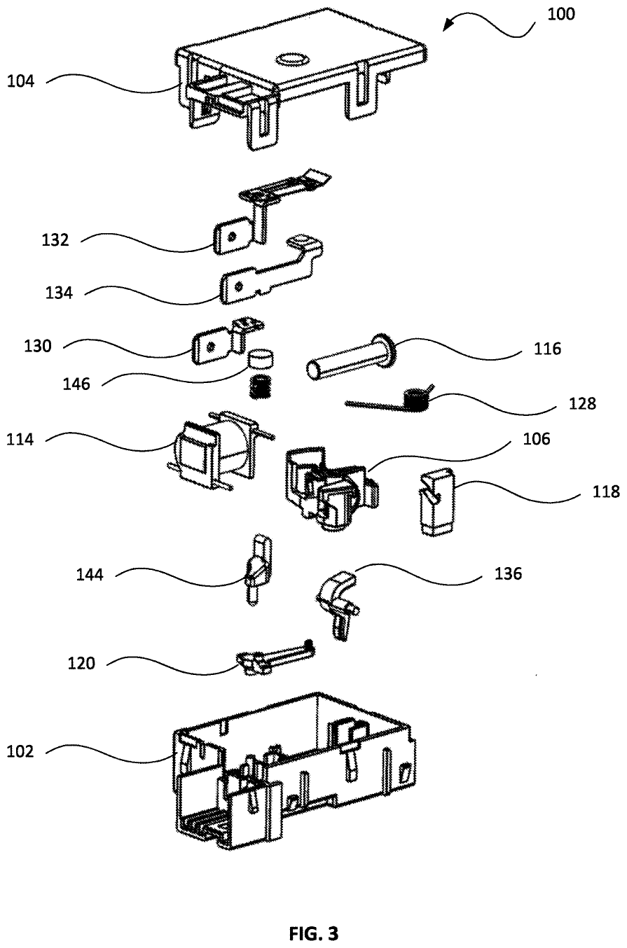

Referring now to FIGS. 2(a), 2(b) and 3, the internal components of the door locking device 100 include a coupling member 106, an actuator having a solenoid 114 and a core 116, a locking pin 118, a guide arm 120, a torsion spring 128, a switch assembly having a first terminal 130, a second terminal 132, and a third terminal 134, a cut-out member 136, a door sensing pin 144, and a PTC pill 146.

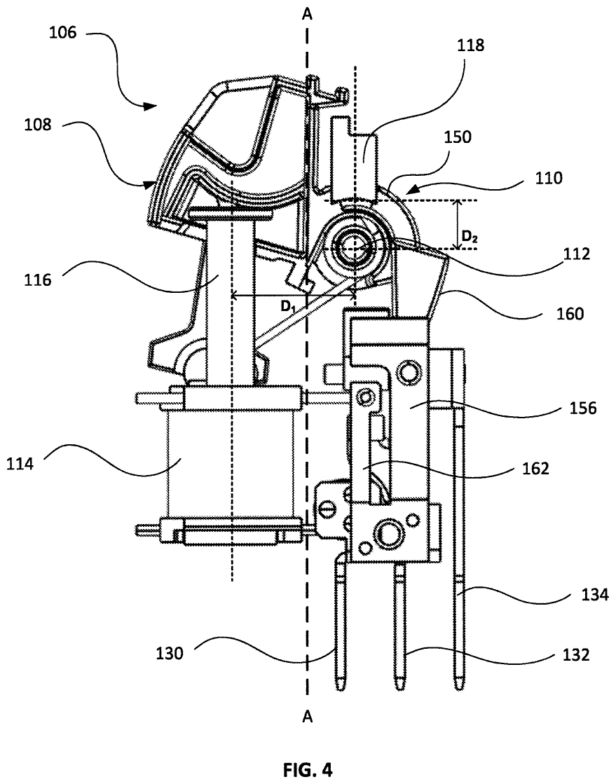

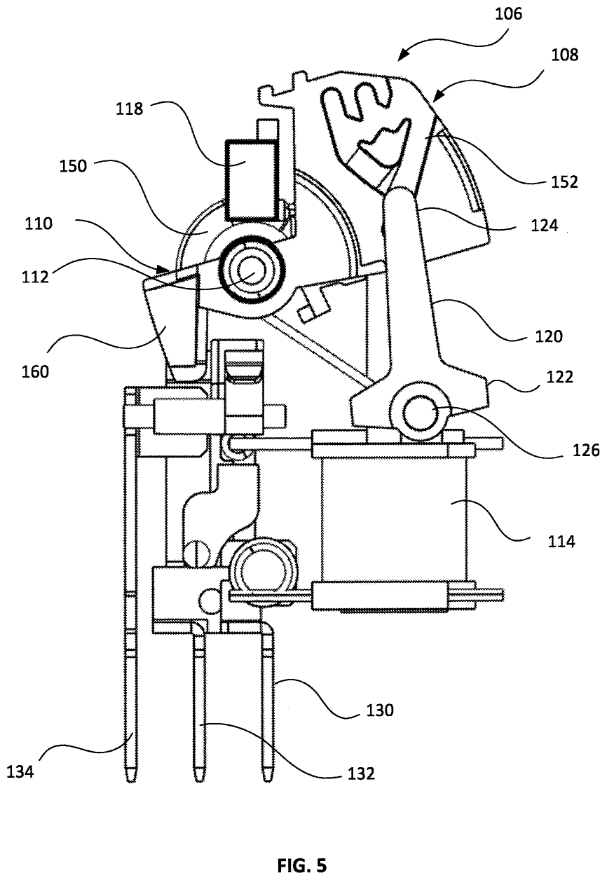

Referring now to FIGS. 4 and 5, the coupling member 106 has a first end portion 108 and a second end portion 110. The coupling member 106 is pivotally mounted in the first housing portion 102 (shown in FIGS. 1 and 3) at a fulcrum 112. The coupling member 106 has a second cam guide 152 provided at the first end portion 108, and a first cam guide 150 and a third cam guide 160 provided at the second end portion 110.

The actuator is provided in the form of a solenoid 114 which has a core 116. The core 116 translates in an axial direction out of the solenoid 114 when a voltage is supplied to the solenoid 114. The core 116 engages a surface of the first end portion 108 of the coupling member 106. The axial translation of the core 116 controls rotational movement of the coupling member 106 between a first position and a second position about the fulcrum 112. However, it is understood by the person skilled in the art that any other suitable actuator may be used to controllably move the coupling member 106. For example, a stepper motor may be used to move the coupling member into predetermined positions according to a digital signal input.

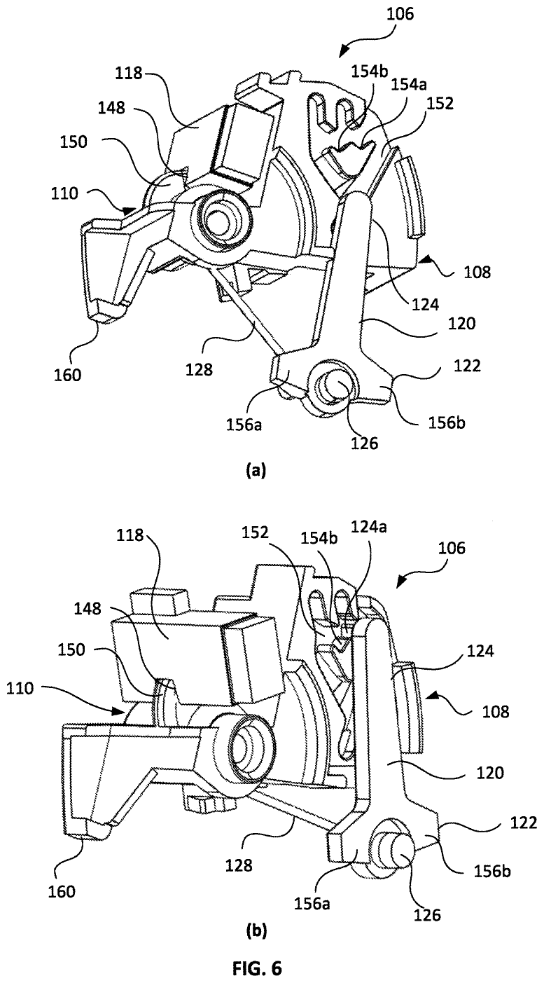

The locking pin 118 has a first cam follower 148 (see FIG. 6(a)) which is slidably coupled to the first cam guide 150 provided at the second end portion 110 of the coupling member 106. The first cam guide 150 is a thread segment extending along a helical path about a pivot axis of the fulcrum 112. The thread segment may cover any suitable angular range to move the locking pin into a desired position. This arrangement of the cam follower 148 and the cam guide 150 causes translational movement of the locking pin 118 between an unlocked position and a locked position when the coupling member 106 is pivoted. In the unlocked position, the locking pin 118 is substantially within the housing so as not to engage the external mechanism of the door lock, for example a door hooking mechanism. In the locked position, the locking pin 118 extends out of the housing.

As shown in FIG. 4, the fulcrum 112 is located between the first end portion 108 and said second end portion 110 of the coupling member 106. Thus, the coupling member 106 provides a mechanical lever between the core 116 of the solenoid actuator and the locking pin 118. A first lever arm distance (D₁) is defined between the core 116 and the fulcrum 112. A second lever arm distance (D₂) is defined between the locking pin 118 and the fulcrum 112. The first distance (D₁) is greater than the second distance (D₂). Thus, the coupling member 106 provides a mechanical lever advantage. Preferably, the ratio between the first distance (D₁) and the second distance (D₂) is greater than 1, preferably, the ratio is from approximately 1.25:1 to 5:1. Due to the mechanical advantage provided by the coupling member 106, the force required by the solenoid actuator to move the locking pin 118 can be reduced. This advantageously allows for a smaller solenoid that can be utilised in the door locking device.

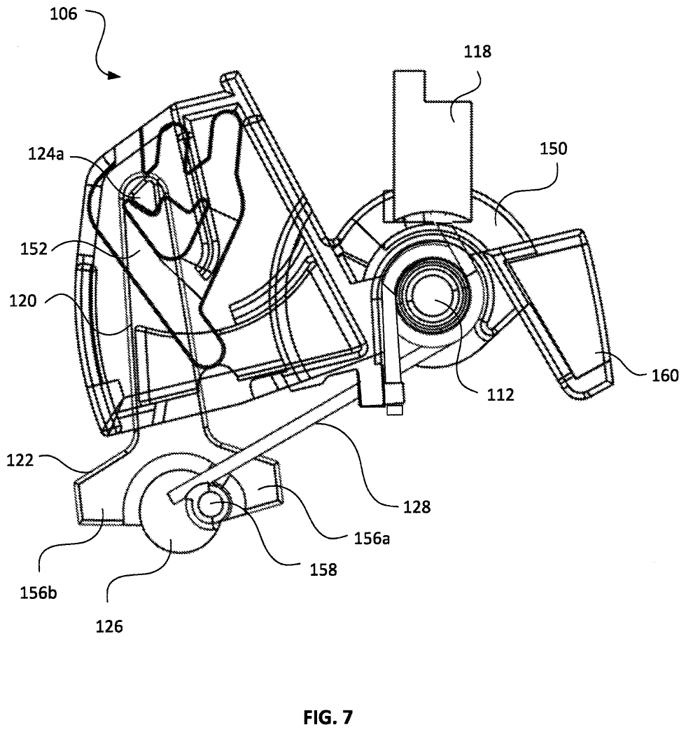

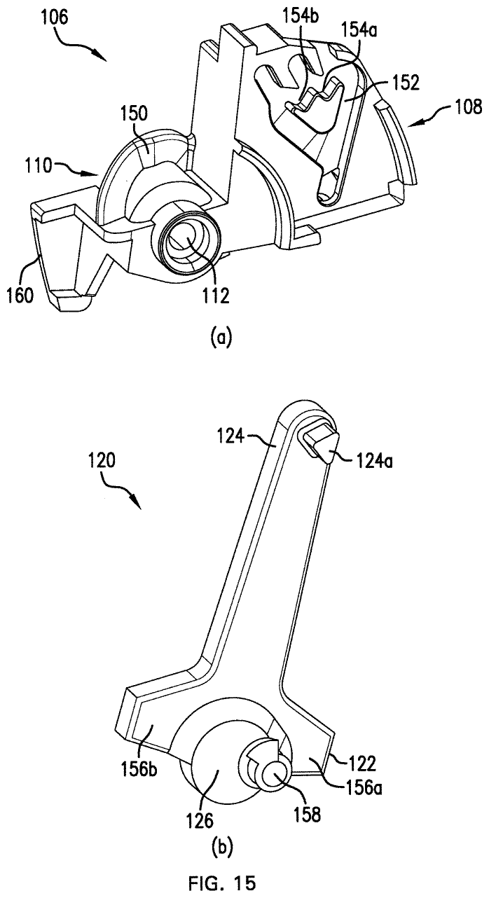

As shown in FIG. 5, a guide arm 120 may be utilised to control the coupling member's 106 movement provided via the solenoid 114 and core 116. In particular, the guide arm 120 is needed to allow for predetermined starting and resting position(s) of the coupling member 106, because the simplistic solenoid actuator 114, 116 used in this particular example only allows for linear core activation/movement depending on a predetermined pulse time. The guide arm 120 may be formed from a thermoplastic polymer or a metal. In particular, the guide arm 120 has a longitudinal axis defined by the length of the guide arm 120 between a first guide arm end portion 122 and a second guide arm end portion 124. The first guide arm end portion 122 is pivotally coupled to the solenoid 114 at a pivot point 126. The second guide arm end portion 124 is provided with a second cam follower in the form of a guide pin 124a (as shown in FIGS. 6(b) and 7). In particular, and as illustrated in FIG. 15(b), the guide pin 124a on the second guide arm end portion 124 is received within a second cam guide 152 provided at the first end portion 108 of the coupling member 106. An alternative embodiment of the second cam guide is illustrated in detail in FIG. 15(a). The second cam guide 152 is a recessed circuit, this provides a forced path for the guide pin 124a to follow as the coupling member 106 pivots. The recessed circuit 152 has a first notch 154a and a second notch 154b, as particularly shown in FIG. 6(a). The guide arm 120 is pivotable about the pivot point 126 between a first arm position and a second arm position. The first and second arm positions are the maximum amplitudes to either side about pivot point 126, which, in this particular example embodiment, are defined by the course of the recessed circuit 152. The first notch 154a and the second notch 154b cooperate with the guide pin 124a on the guide arm 120 to latch the coupling member 106 in a first predetermined resting position and a second predetermined resting position. According to another alternative embodiment, the recessed circuit 152 may only have one notch (the first notch 154a) capable of latching the coupling member in the first predetermined resting position. Further, any other suitable number of notches may be used to provide additional resting positions of the coupling member 106. In this particular embodiment of the present invention, the guide pin 124a has a triangular cross-sectional profile, however, it is understood by the person skilled in the art that the guide pin can have any suitable cross-sectional profile suitable to operably cooperate with the second cam guide or recessed circuit 152.

Referring now to FIGS. 6(a), 6(b) and 7, the first guide arm end portion 122 has two radially opposing stop members 156a and 156b protruding laterally away from the longitudinal axis of the guide arm 120. As shown in FIG. 7, the stop member 156a closest to the fulcrum 112 is provided with a pin 158. The pin 158 is radially offset from the pivot point 126, thereby defining a lever between the second guide arm end portion 124 and the pin 158 about said pivot point 126.

A torsion spring 128 is connected between the pin 158 and the coupling member 106. Here, the torsion spring 128 is coiled about the fulcrum 112 in order to provide a bias between the guide arm 120 and the coupling member 106. This arrangement biases the coupling member 106 towards its first position. This arrangement of the torsion spring 128 also biases the guide arm 120 towards its first arm position (i.e. towards the fulcrum 112). Furthermore, this arrangement biases the guide arm 120 towards the coupling member 106 to maintain engagement between the guide pin 124a and the recessed circuit 152. According to the embodiment discussed herein, a torsion spring 128 provides a bias to the coupling member 106. According to alternative embodiments, any other suitable biasing member may be used, for example any other suitable spring or a biasing member formed from a rubber or elastomer material having resilient properties.

The guide arm 120 may be made by thermoplastic polymer or metal properly designed.

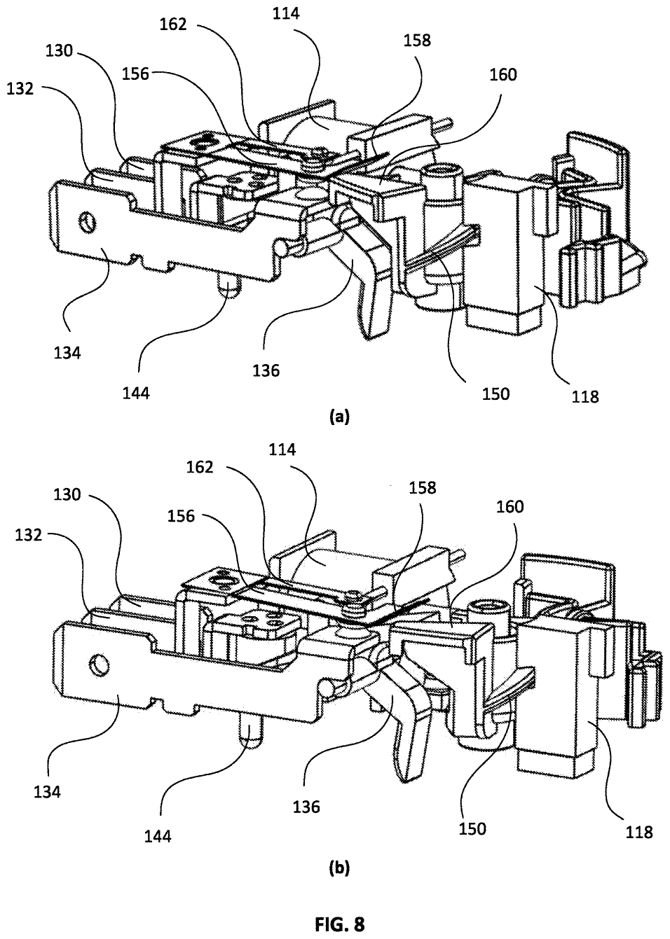

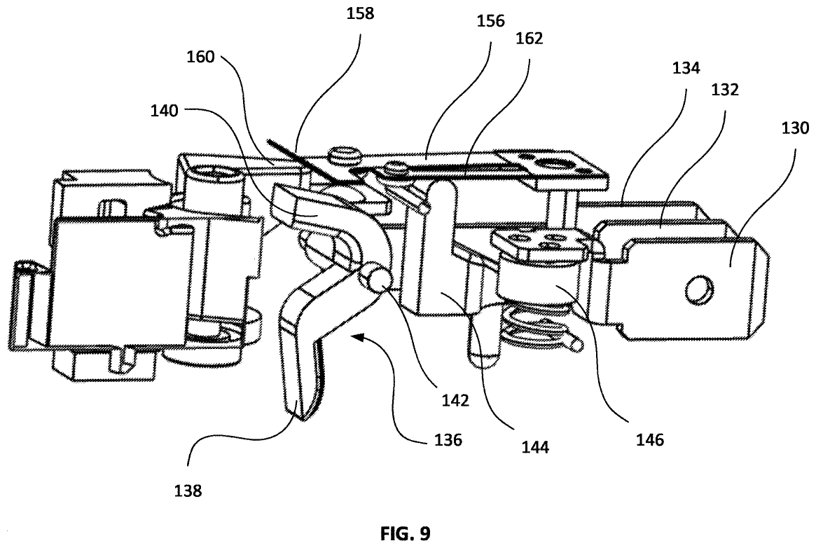

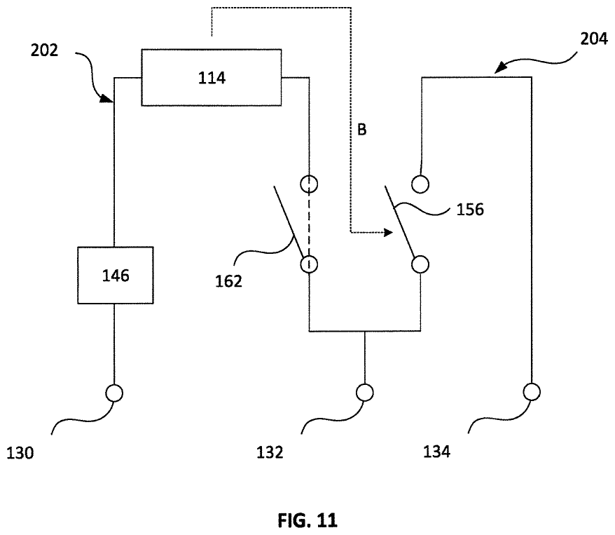

Referring now to FIGS. 8(a), 8(b) and 9, the switch assembly includes a first terminal 130, a second terminal 132 and a third terminal 134. The first terminal 130 is electrically connected to the solenoid 114. The second terminal 132 is also electrically connected to the solenoid 114 so as to form an electrical power circuit with the first terminal 130 and a power source circuit of the household appliance. This circuit will drive the solenoid 114 and core 116. A third terminal 134 is selectively electrically connectable to the second terminal 132 and an external interface so as to form a signal circuit with a controller of the household appliance. As shown in FIG. 11, the first terminal 130 and the second terminal 132 form a first circuit 202 which connects to a power circuit of the household appliance. The second terminal 132 and the third terminal 134 form a second circuit 204 which selectively connect the power source to a controller of the household appliance. The second terminal 132 has a main switch element 156 connected between the second terminal 132 and the third terminal 134. The main switch element 156 may be a resilient conductive plate. The main switch element 156 is biased towards a closed position in which the main switch element 156 contacts the third terminal 134 to provide an electrical connection between the second terminal 132 and the third terminal 134. The main switch element 156 is mechanically actuated via the solenoid 114 and subsequent rotation of the coupling member 106, as indicated by arrow B.

The main switch element 156 has a third cam follower 158 that cooperates with a third cam guide 160 provided on the coupling member 106. The third cam guide 160 is a protrusion adjacent to the first cam guide 150 at the second end portion 110 of the coupling member 106. When the coupling member 106 is in the first position, the third cam guide 160 engages the third cam follower 158 to move the main switch element 156 out of contact with the third terminal 134. When the coupling member 106 is pivoted to the second position, the third cam guide 160 releases the third cam follower 158 causing the main switch element 156 to contact the third terminal 134, thereby closing the second circuit 204.

According to one embodiment of the claimed invention, as shown in FIGS. 9 and 11, the second terminal 132 may also have a door sensing switch element 162 connected between the second terminal 132 and the solenoid 114. The door sensing switch element 162 may be a resilient conductive plate. The door sensing switch element 162 is biased towards a closed position in which the door sensing switch element 162 contacts the solenoid 114 to provide an electrical connection between the second terminal 132, the solenoid 114, the first terminal 130 and the power source circuit of the household appliance. As shown in FIG. 9, the door sensing pin 144 is positioned below the door sensing switch element 162. The door sensing pin 144 is slidably positioned within the first housing portion 102. The door sensing pin 144 is moved into contact engagement with the door sensing switch element 162 when the door of the household appliance is open moving the door sensing switch element 162 into its open position and disengaged from the door sensing switch element 162 when the door of the household appliance is closed allowing the door sensing switch element 162 to return back (due to its inherent bias) to its closed position.

Alternatively, the second terminal may be a permanent electrical connection, i.e. it does not comprise a switch element for selectively interrupting the electrical connection to the actuator 114. Here, the household appliance may not be provided with a door sensing pin.

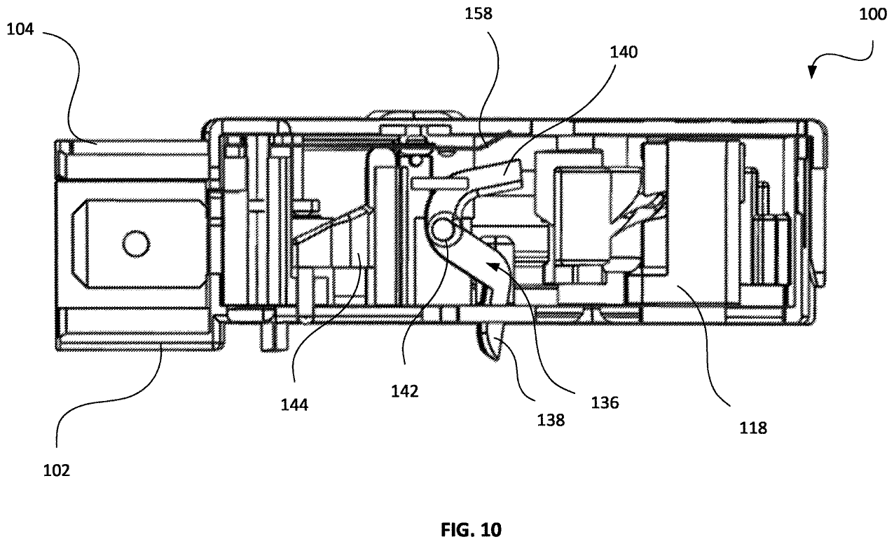

Further, as shown in FIGS. 9 and 10, the door locking device 100 may also include a cut-out member 136. The cut-out member 136 has a first end 138 and a second end 140, and a fulcrum 142 provided therebetween such that the cut-out member 136 can pivot about the fulcrum 142. The first end 138 of the cut-out member 136 protrudes from the first housing portion 102. The second end 140 of the cut-out member 136 has a cut-out cam guide. The cut-out cam guide is positioned below the third cam follower 158 provided on the main switch element 156. In case a user attempts to force open the door of the household appliance whilst the door is locked, the locking pin 118 or a linear or rotary locking slider that cooperates with the locking pin in an external locking mechanism (not shown) could break. Thus, the linear or rotary locking slider engages the first end 138 of the cut-out member 136 causing the cut-out member 136 to pivot about the fulcrum 142. Pivoting of the cut-out member 136 causes the cut-out cam guide at the second end 140 to engage the third cam follower 158 of the main switch element 156 and lift the main switch element 156 out of contact with the third terminal 134, thereby breaking the second circuit 204.

Referring now to FIGS. 9 and 11, according to one embodiment of the claimed invention, a Positive Temperature Coefficient (PTC) thermistor 146 is provided in the first circuit 202 between the first terminal 130 and the solenoid 114. The PTC thermistor 146 provides a safety feature which cuts power to the solenoid 114. The PTC thermistor is a temperature dependent resistor adapted to prevent overheating of the circuitry from excessively large current flows by increasing the electrical resistance with increasing temperature.

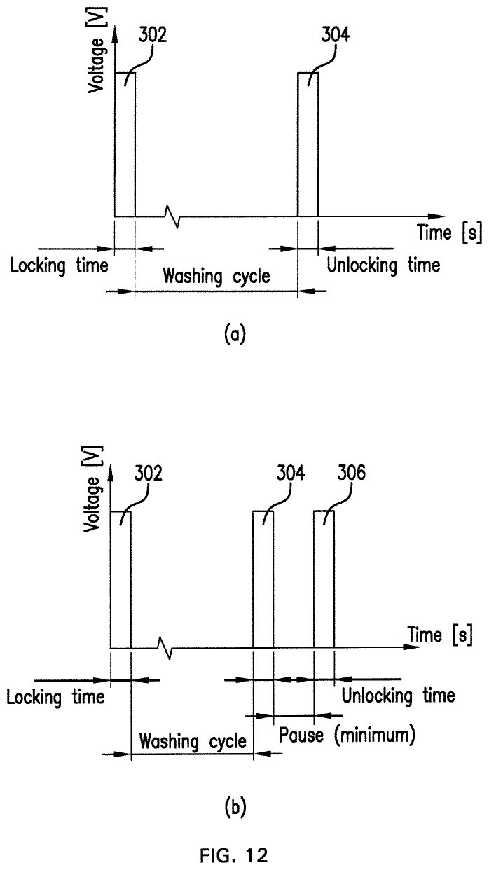

As previously discussed, the door locking device 100 may be installed within the household appliance and operably coupled to a door hooking mechanism (not shown). The door hooking mechanism, could be any suitable mechanism that is operably coupleable with the door locking device of the present invention. Typically, the door hooking mechanism has a safety slider and a locking slider. The safety slider may have a cam surface configured to engage with the door sensing pin 144 so as to move and retain the door sensing pin 144 in a raised position, i.e., in a position where the sensing pin 144 engages with and opens the door sensing switch element 162. The door hooking mechanism may further comprise a rotary cam configured to engage a door hook provided on the door of the appliance when the door is closed. In this particular example, pivoting of the rotary cam when the rotary cam engages the door hook moves the safety slider in a lateral direction such that the door sensing pin 144 is moved down the sloped cam surface and out of engagement with the door sensing switch 162, thus closing the first circuit 202. When the first circuit 202 is closed, the solenoid 114 is connected to power via the second terminal 132. This allows for a voltage differential to be supplied to the solenoid 114 in the form of pulses to move the core 116 within the solenoid 114 and actuate the rotation of the coupling member 106. Examples of control pulses are shown in FIGS. 12(a) and (b). Here, the working cycle of a washing machine may utilise a ‘1+1’ pulse pattern (the cam guide may only include one resting position provided by a single first notch 154a) as illustrated in FIG. 12(a). In this particular example, the first and second impulse 302, 304 may have a duration of about 0.02 seconds, however, it is understood by the person skilled in the art that any other suitable pulse length may be used to move the core 116 and coupling member 106 between predetermined positions.

In another example, the working cycle may utilise a ‘1+2’ pulse pattern as shown in FIG. 12(b). Here, a first and second notch 154a, 154b are required to provide two resting positions for the coupling member 106. As with the ‘1+2’ working cycle, in this example the duration of the impulses are 0.02 seconds, with a 0.2 second gap between the last two pulses 304, 306, however, any other suitable pulse length and/or gap length may be used to move the core 116 and coupling member 106 between predetermined positions. Once the door of the household appliance is closed, the door locking device can be operated.

As alternative, there may be provided a mechanism with ‘1+1’ pulse pattern, which is provided with a first notch 154a only. In this example the duration of the impulses are 0.02 seconds.

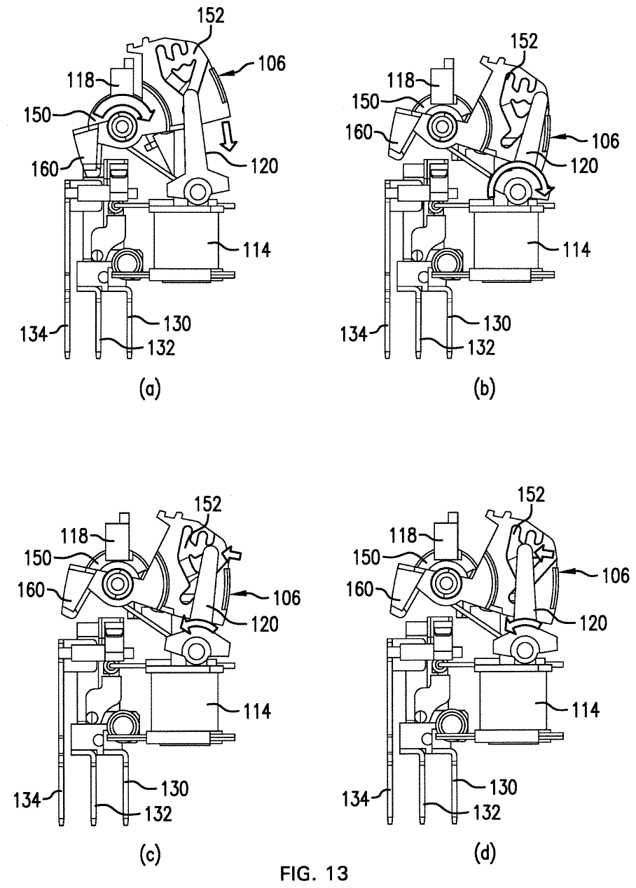

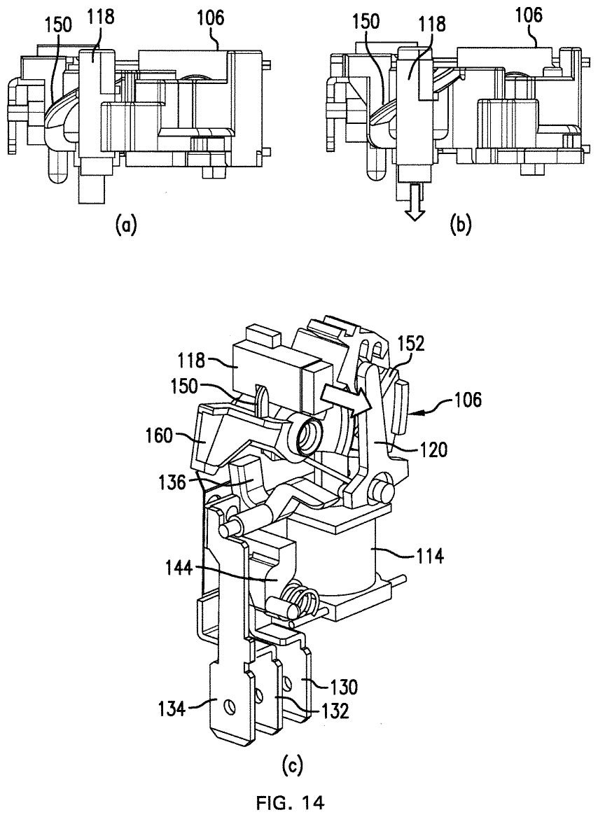

The function of the door locking device 100 is now described in more detail with particular reference to FIGS. 6 to 8, as well as, 13 and 14. To activate the door lock, a controller of the household appliance may provide a first 20 ms voltage pulse 302 to the solenoid 114 energising the solenoid 114 and causing the core 116 to axially move and pivot the coupling member 106 from its first position (shown in FIG. 6(a) and FIG. 13(a)) to a second position (shown in FIG. 6(b) and FIG. 13(b)). When the solenoid 114 is energised by the voltage pulse, the solenoid 114 generates a magnetic field that applies a magnetic force to the core 116, pulling the core 116 into the solenoid 114, thereby pivoting the coupling member 106 to the second position. As shown in FIGS. 6(b) and 13(b), pivoting of the coupling member 106 from the first position to the second position causes the guide pin 124a on the second guide arm end portion 124 to follow the recessed circuit 152. When the voltage pulse ends, the solenoid 114 is no longer energised and magnetic force on the core 116 is removed. The coupling member 106 will pivot back towards the first position due to the bias provided by the torsion spring 128. As the coupling member 106 pivots back towards the first position, the guide pin 124a will latch into the first notch 154a (see FIGS. 6(b) and 13(c)), thereby latching the coupling member 106 in the first predetermined resting position. In the first predetermined resting position, as shown in FIGS. 6(b), 8(b) and 14(b), (c) the locking pin 118 is in the forward locked position and the third cam guide 160 releases the main switch element 156 so as to close the second circuit 204 and provide the power source voltage to the third terminal 134. This voltage change may be used by the controller of the household appliance to generate a signal (visual, audible) indicating the status of the door lock. When the locking pin 118 is held in the locked position, the locking slider of the door hooking device is blocked. This prevents pivoting of the rotary cam, thereby holding the door hook in place and locking the door of the household appliance. The washing cycle can then commence.

Once the washing cycle is complete, the controller of the household appliance may generate a second voltage pulse 304 and a third voltage pulse 306 supplied to the solenoid 114 in a predetermined sequence (e.g., 20 ms pulses with a 200 ms time gap) as shown in FIG. 12(b). The second voltage pulse 304 causes the solenoid 114 to again become energised and apply a magnetic force to the core 116 to again pull the core 116 axially into the solenoid 114 whilst it remains energised. This combination of axial core 116 movement and spring bias of the coupling member 106 causes the coupling member 106 to move in a rocking motion, pivoting towards its second position when the solenoid 114 is energised and the core 116 is pulled axially into the solenoid, and back towards its first position when the core 114 is no longer energised due to bias provided by the torsion spring 128. This causes the guide pin 124a to unlatch from the first notch 154a and move into the second notch 154b (see FIG. 13(d)), thereby latching the coupling member 106 in a second predetermined resting position. The third voltage pulse 305 causes the solenoid 114 to again become energised and apply a magnetic force to the core 116 to again pull the core 116 axially into the solenoid 114 whilst it remains energised. The core 116, again pivots the biased coupling member 106 towards its second position as it is pulled into the solenoid 114. Again, the combination of the axial core movement and spring biased urge of the coupling member 106 to return to its first position causes the guide pin 124a to unlatch from the second notch 154b and move back into its starting position (see FIG. 6(a)). As shown in FIGS. 6(a), 8(a) and 14(a), when the coupling member is in the first, starting position, the locking pin 118 is in the unlocked position and the third cam guide 160 engages and lifts the main switch element 156 to open the second circuit 204. Movement of the locking pin 118 to the unlocked position releases the locking slider of the door hooking device, allowing the rotary cam of the door hooking device to pivot when a force is applied to the door of the household appliance that is transferred to the door hook. The door of the household appliance can then be opened. Opening of the door moves the door sensing pin 144 into contact with the door sensing switch element 162 to lift the door sensing switch element 162, thereby opening the first circuit 202 and cutting the power supply to the solenoid 114.

According to an alternative embodiment of the claimed invention, as shown in FIG. 12(a), only one voltage pulse (the second voltage pulse 304) is supplied to the solenoid 114 to unlock the door locking device. In this embodiment, only a first notch 154a is provided in the second cam guide 152.

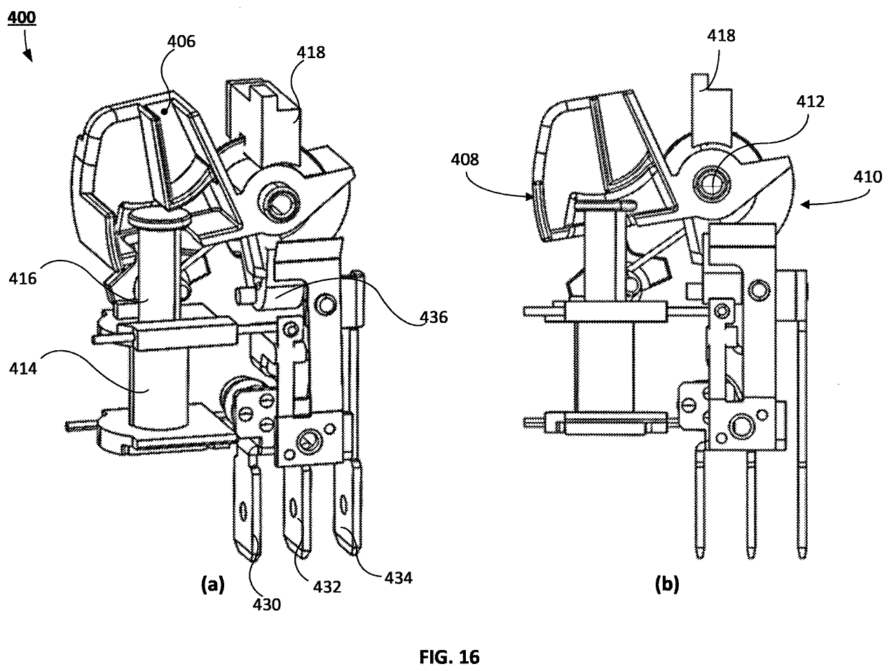

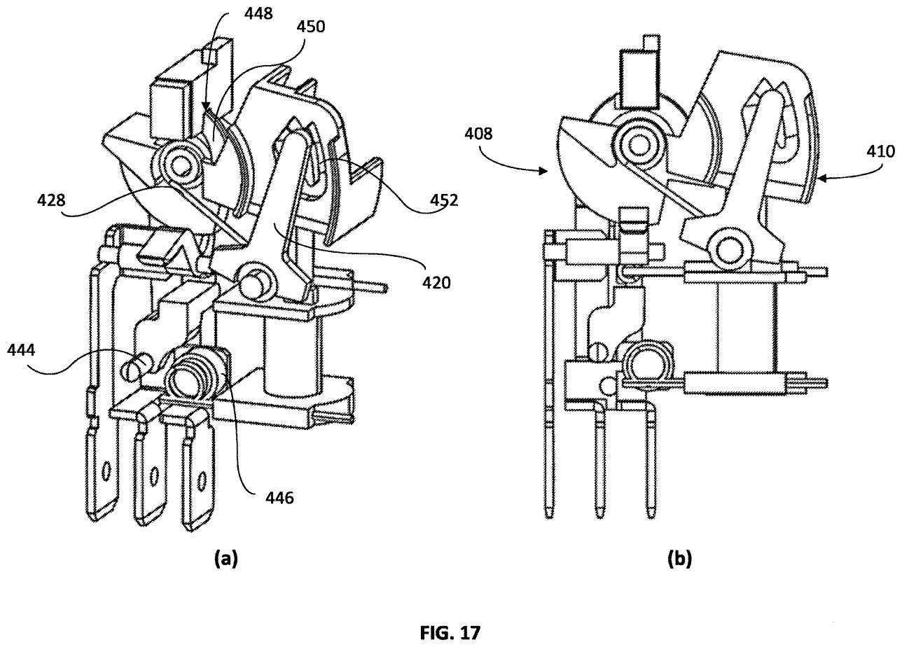

FIGS. 16 to 22 show yet another alternative embodiment of the locking device 400 of the claimed invention. The mechanism and general function of the alternative door locking device 400 is substantially the same as the embodiment of the door locking device 100 and only structural and functional differences will be described herein. In particular, the locking device 400 comprises an altered coupling member 406 having, inter alia, a reversed first cam guide 450 at the second end portion 410. Thus, during operation, the coupling member 406 is moved into its first position (i.e., locking pin 418 is in its locked position) via the actuation of the solenoid 414 and core 416, and biased towards its second position (i.e., the locking pin 418 is in its unlocked position) via the torsion spring 428.

Further, coupling member 406 of the locking device 400 comprises a third cam guide 460 at the second end portion 410 in the form of a ramp adapted to operably engage with the third cam follower 458 of the main switch element 456. In this example, the third cam guide 460 engages the third cam follower 458 of the main switch element 456 via the cut-out element 436. However, the third cam guide 460 is also adapted to operably engage with the third cam follower 458 directly, i.e., without the cut-out element 436 mounted in-between. Without the cut-out element 436, the third cam follower 458 of the resilient main switch element 456 simply slides over the ramp to when the coupling element is moved between its first and second position so as to move the main switch element 456 into and out of contact with the third terminal 434, thereby connecting/breaking the second circuit 204 (see FIG. 11, embodiment of locking device 100). One of the advantages of changing the third cam guide 460 from a protrusion (see third cam guide 160) to a more integrated ramp is that overall dimensions of the locking device mechanism can be further reduced.

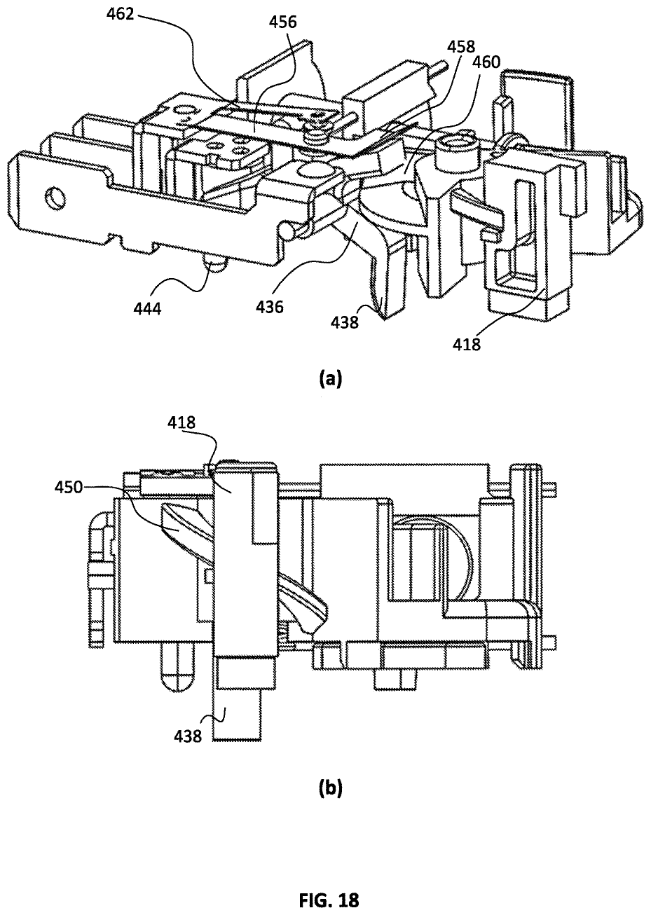

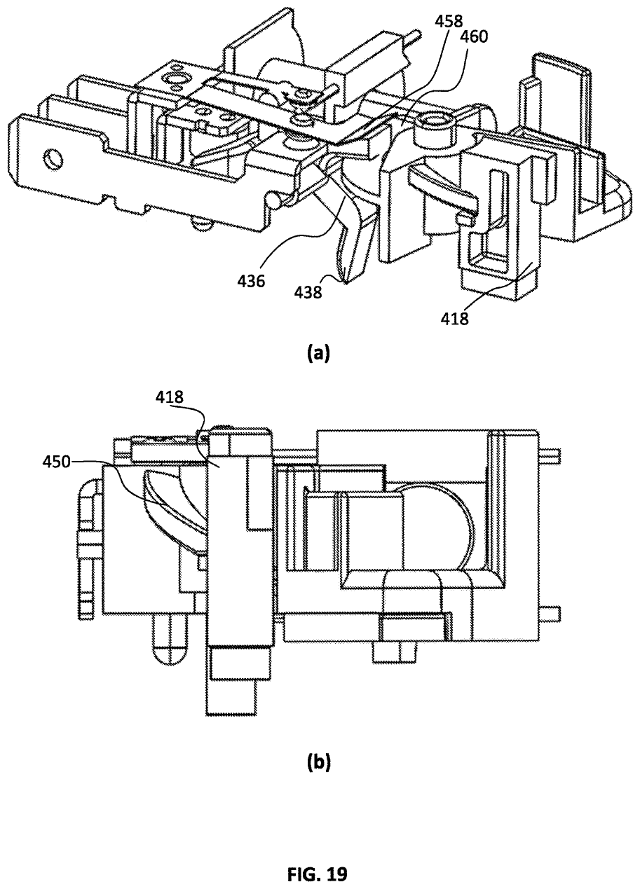

In use, and referring particularly to FIGS. 18 and 19, the locking pin 418 is in its unlocked position when the coupling member 406 is in its second position with the core 416 of the solenoid 414 being pushed out. In this position, the ramp of the third cam guide 460 pushes the cam follower 458 of the main switch element 456 up and out of contact with the third terminal 434. When the coupling member 406 is moved into its first position, the locking pin 418 is moved via the first cam guide 450 from the unlock position into its locked position, wherein the cam follower 458 of the main switch element 456 is moved down the ramp of the third cam guide 460 into engagement with the third terminal 434 closing the second circuit

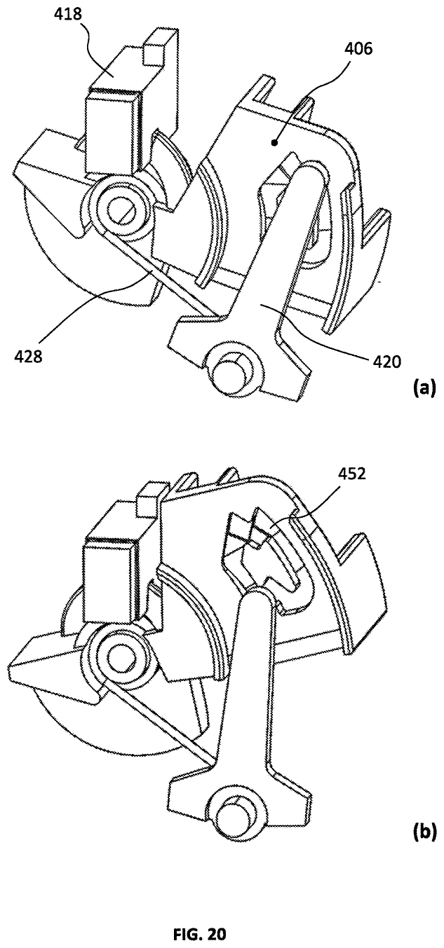

FIG. 20 shows the alternate coupling member 406, coupled with the locking pin 418 and guide arm 420 (with torsion spring 428), (a) in its second position, i.e., with the looking pin 418 in the retracted unlocked position and (b) in its first position, i.e., with the looking pin 418 in the pushed out locked position.

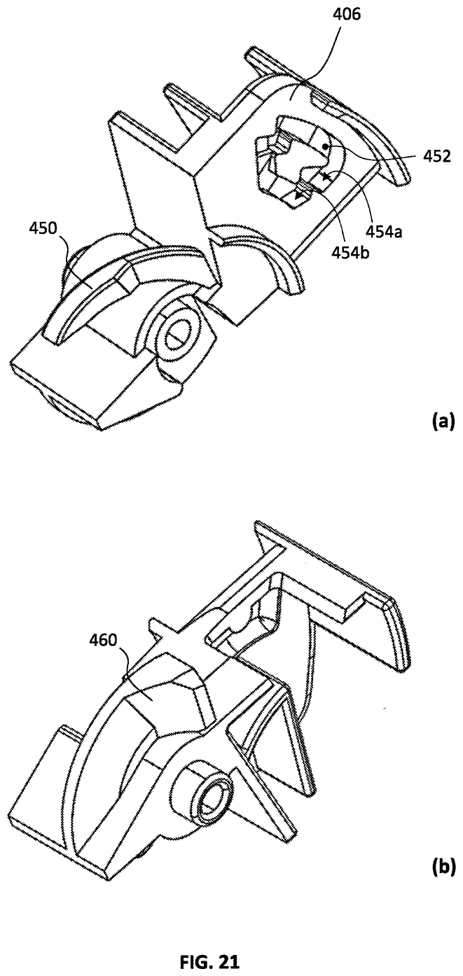

FIG. 21 shows the alternate coupling member 406 in detail and without any of the other components, (a) showing the first cam guide 450 adapted to engage with the locking pin 418, and (b) showing the third cam guide 460 adapted to engage with the third cam follower 458 with or without an interjacent cut-out element 436. Further, FIG. 21(a) shows the second cam guide 452 in more detail including the full guide path for the guide pin 424a of the guide arm 420. In particular, the guide path of this particular example utilises a ‘1+2’ pulse pattern as described for the locking device 100 (see FIG. 12(b)), so first notch 454a and second notch are provided within the guide patch (but opposite to the embodiment of locking device 100). During use, the guide pin 424a moves from the unlocked position (at the top of the guide path) down to the first notch 454a into the locked position. Two pulses (solenoid actuator 414) are then used to move the guide pin 424a from the first notch 454a into the second notch 454b (first pulse) and back to the unlocked position (second pulse).

Alternatively, the guide path of the second cam guide 452 may only comprise a first notch 454a, so as to provide a mechanism with a ‘1+1’ pulse pattern.

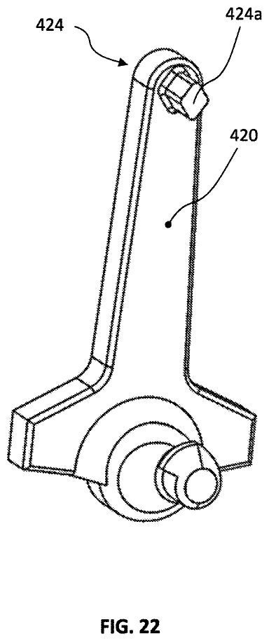

FIG. 22 shows the guide arm 420 in detail comprising a suitable guide pin 424a at its end portion 424.

It will be appreciated by persons skilled in the art that the above embodiment(s) have been described by way of example only and not in any limitative sense, and that various alterations and modifications are possible without departing from the scope of the invention as defined by the appended claims. Various modifications to the detailed designs as described above are possible, for example, variations may exist in shape, size, arrangement (i.e., a single unitary component or two separate components), assembly or the like.

### LIST OF REFERENCE NUMBERS

100 door locking device
102 first housing portion
104 cover portion
106 coupling member first end portion of the coupling
108 member second end portion of the
110 coupling member
112 fulcrum
114 solenoid
116 core
118 locking pin
120 guide arm
122 first guide arm end portion
124 second guide arm end portion
124a guide pin
126 pivot point
128 biasing member/torsion spring
130 first terminal
132 second terminal
134 third terminal
136 cut-out element
138 first end of the cut-out element second end of the cut-out
140 element
142 fulcrum of the cut-out element
144 door sensing pin
146 PTC thermistor
148 first cam follower
150 first cam guide
152 second cam guide
154a first notch
154b second notch
156 main switch element
158 third cam follower
160 third cam guide
162 door sensing switch element
202 first circuit
204 second circuit
302 first voltage pulse
304 second voltage pulse
306 third voltage pulse
400 alternative door locking device
406 alternative coupling member
408 first end portion of 406
410 second end portion of 406
412 fulcrum
414 solenoid
416 core
418 locking pin
420 guide arm
424 second guide arm end portion
424a guide pin
428 torsion spring
430 first terminal
432 second terminal
434 third terminal
436 cut-out element
438 first end of the cut-out element
444 door sensing pin
446 PTC thermistor
448 first cam follower
450 first cam guide
452 second cam guide
454a,b First and second notch
456 main switch element
458 third cam follower
460 third cam guide
462 door sensing switch element

1. A door locking device (100) for a door of a household appliance, the device comprising:
a housing (102, 104);
a coupling member (106), having a first end portion (108) and a second end portion (110), pivotally mounted at a fulcrum (112) within the housing;
an actuator (114), operably coupled to the first end portion of the coupling member and adapted to controllably move the coupling member between a first position and a second position about the fulcrum;
a locking pin (118), operably coupled to the second end portion of the coupling member and configured to slidably move between an unlocked position, when the coupling member is in the first position, and a locked position, when the coupling member is in the second position;
wherein the fulcrum is located between the first end portion and the second end portion so as to provide a mechanical lever advantage for a force applied to the first end portion by the actuator and imparted onto the locking pin by the second end portion.

2. The door locking device according to claim 1, wherein the second end portion of the coupling member comprises at least one first cam guide operably coupled with a corresponding first cam follower of the locking pin.

3. The door locking device according to claim 2, wherein the cam guide is provided by a thread member coaxially arranged with and extending about a pivot axis of the fulcrum.

4. The door locking device according to claim 3, wherein the thread member is a thread portion defining a predetermined thread segment along a helical path about the pivot axis of the fulcrum.

5. The door locking device according to claim 1, further comprising a guide arm, having a longitudinal axis and extending between a first guide arm end portion, pivotally coupled to the actuator at a pivot point, and a second guide arm end portion, operably coupled to the first end portion of the coupling member, wherein the guide arm is configured to move about the pivot point between a first arm position and a second arm position, and wherein the guide arm is adapted to latch the coupling member in at least one predetermined resting position when the coupling member is moved between the first position and second position.

6. The door locking device according to claim 5, further comprising a biasing member operably coupled to the coupling member and configured to bias the coupling member towards the first position.

7. The door locking device according to claim 6, wherein the biasing member is operably coupled to the guide arm and configured to bias the guide arm towards the first arm position.

8. The door locking device according to claim 7, wherein the first arm position is towards the fulcrum of the coupling member.

9. The door locking device according to claim 6, wherein the biasing member is a torsion spring.

10. The door locking device according to claim 5, wherein the guide arm comprises a second cam follower at the second guide arm end portion configured to operably couple with a corresponding second cam guide at the first end portion of the coupling member.

11. The door locking device according to claim 10, wherein the second cam guide is a guide path defined by a recessed circuit.

12. The door locking device according to claim 1, further comprising a switch assembly, the switch assembly comprising:
a first terminal, electrically connected to the actuator,
a second terminal, electrically connected to the actuator so as to form an electrical power circuit with the first terminal and a power source circuit of the household appliance, and
a third terminal, selectively electrically connectable to the second terminal and an external interface so as to form a signal circuit with a controller of the household appliance.

13. The door locking device according to claim 12, wherein the third terminal comprises a main switch element moveable between an open position in which the third terminal is electrically disconnected from the second terminal, and a closed position in which the third terminal is electrically connected to the second terminal.

14. The door locking device according to claim 13, wherein the main switch element of the third terminal comprises a third cam follower configured to operably engage with a corresponding third cam guide provided at the second end portion of the coupling member so as to move the main switch element between said the open position and the closed position in accordance with respective the first position and the second position of the coupling member.

15. The door locking device according to claim 14, wherein the main switch element is biased towards the closed position.

16. The door locking device according to claim 13, further comprising a cut-out member, adapted to operably engage with the third cam follower and move the main switch element into the open position when the cut-out member is actuated.

17. The door locking device according to claim 12, wherein the second terminal comprises a door sensing switch element moveable between an open position in which the actuator is electrically disconnected from the power source circuit, and a closed position in which the actuator is electrically connected to the power source circuit.

18. The door locking device according to claim 17, wherein the door sensing switch element is biased towards the closed position.

19. The door locking device according to claim 18, further comprising a door sensing pin operably coupled between the door of the household appliance and the door sensing switch element of the second terminal, the door sensing pin configured to move between an engaged position when the door is open, retaining the door sensing switch element into the open position, and a disengaged position when the door is closed, where the door sensing switch element is in the closed position.

20. The door locking device according to claim 12, further comprising a PTC (Positive Temperature Coefficient) thermistor operably coupled between the actuator and the first terminal.

21. The door locking device according to claim 1, wherein the actuator comprises:
a solenoid, and
a core, slidably received within the solenoid and operably coupled to the first end portion of the coupling member.
